(19) United States
(12) Patent Application Publication
(10) Pub. No.: US 2025/0097174 A1
(43) Pub. Date: Mar. 20, 2025

(54) CLOUD-BASED COMMUNICATIONS SYSTEM

(71) Applicant: OUR VITA TECHNOLOGY LTD., Delta (CA)

(72) Inventor: Frank RACANELLI, Delta (CA)

(21) Appl. No.: 18/890,532

(22) Filed: Sep. 19, 2024

Related U.S. Application Data
(60) Provisional application No. 63/539,257, filed on Sep. 19, 2023.

(51) Int. Cl. H04L 51/04; A63H 3/00; A63H 3/02; A63H 3/28; H04L 51/10

(52) U.S. Cl. CPC H04L 51/04; A63H 3/006; A63H 3/28; H04L 51/10; A63H 3/02; A63H 2200/00

(57) ABSTRACT

A communications system includes a server and devices. Each device is associated with a user and includes a transceiver, a light, and inputs. A device is linked with other devices, with each of the devices associated with a different unique color selected by the user. The device transmits a message to a particular other one of the devices by (1) the user selecting, using the inputs and the light, the different unique color associated with the particular other one of the devices, and (2) the device transmitting the message to the server. The server determines which of the other devices is the particular one of the devices to which the message is intended. Each of the other devices connects with the server, and upon the particular other one of the devices connecting with the server, the server transmits the message to the particular other one of the devices.

### CROSS-REFERENCE TO RELATED APPLICATIONS

This application claims the benefit of U.S. Provisional Patent Application No. 63/539,257 filed Sep. 19, 2023, the contents of which are hereby incorporated by reference.

### TECHNICAL FIELD

The present disclosure relates to communications among multiple devices over a network, and in particular, to communications involving light, vibration, and/or audio among multiple devices over a network.

### BACKGROUND

The use of light, vibration, and/or audio for communicating or conveying information is known. For example, messages such as “Go”, “Stop”, “Walk”, and/or “Don't Walk” may be communicated using one or more of light, vibration, or audio cues. However, in most cases, the sender and the recipient of such messages are typically in close proximity to each other, so as to be able to perceive the light, vibration, or audio cues.

### SUMMARY

In accordance with one aspect, a communications system among users comprises a server and a plurality of devices. Each of the devices is associated with one of the users and comprises a transceiver, a light, and one or more inputs. The transceiver is configured to communicate with the server. One of the devices is configured to be linked with other ones of the devices, with each of the other ones of the devices associated with a different unique color selected by the user associated with the one of the devices from a plurality of colors. The one of the devices is configured to transmit a message to a particular one of the other ones of the devices by (1) the user associated with the one of the devices selecting, using the one or more inputs and the light, the different unique color associated by the one of the devices with the particular one of the other ones of the devices, and (2) the one of the devices transmitting the message to the server. The server, upon receipt of the message, is configured to determine which of the other ones of the devices is the particular one of the other ones of the devices to which the message is intended. Each of the other ones of the devices is configured to connect with the server, and upon the particular one of the other ones of the devices connecting with the server, the server is configured to transmit the message to the particular one of the other ones of the devices.

In another aspect, the communications system further comprises a database in communications with the server. The database is configured to store information relating to the different unique colors associated by each of the devices with the other ones of the devices linked to each of the devices.

In yet another aspect, upon receipt of the message by the particular one of the other ones of the devices, the light on the particular one of the other ones of the devices is configured to illuminate with the different unique color associated by the particular one of the other ones of the devices with the one of the devices.

In still yet another aspect, the selecting of the different unique color associated by the one of the devices with the particular one of the other ones of the devices is by using the one or more inputs to sequentially display, using the light, the plurality of colors to select the different unique color.

In a further aspect, each of the devices further comprises a microphone, and the message comprises an audio recording recorded by the microphone.

In still a further aspect, each of the devices further comprises a speaker, and upon receipt of the message by the particular one of the other ones of the devices, the particular one of the other ones of the devices is configured to play the audio recording using the speaker.

In another aspect, the one or more inputs comprises two inputs.

In still another aspect, at least one of the devices is in a form of a plush toy.

In yet still another aspect, the plush toy comprises two or more appendages.

In a further aspect, at least one of the one or more inputs is located proximate to one of the appendages.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 depicts a schematic of the system in accordance with one embodiment;

FIG. 2 depicts a schematic of the components of the device of the system;

FIG. 3 depicts one embodiment of the device of FIG. 2;

FIG. 4 depicts a flowchart of the operation of the device in accordance with one embodiment;

FIG. 5 depicts an example of a color table; and

FIG. 6 depicts communications between two of the users, in accordance with one embodiment.

### DETAILED DESCRIPTION

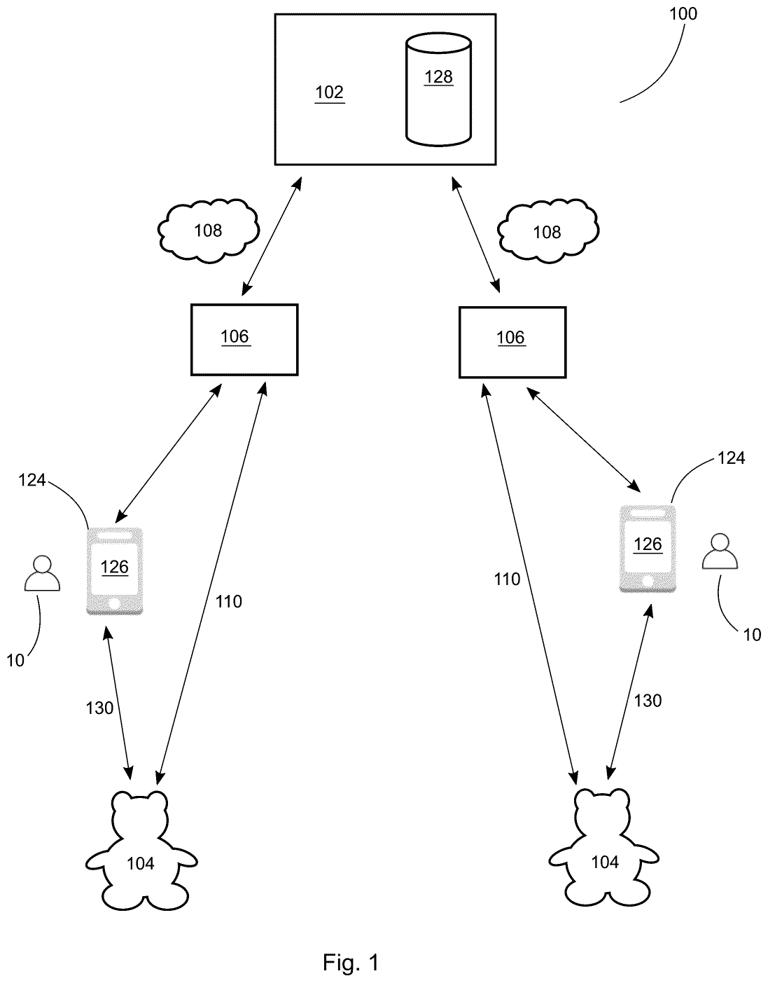

Referring to FIG. 1, a system 100 in accordance with one embodiment comprises a server 102 and a plurality of devices 104. Although FIG. 1 only depicts two of the devices 104, it is understood that a greater number of the devices 104 may be present in the system 100. The system 100 may further comprise a number of network routers 106 that are configured to communicate with the server 102. The communications between the network routers 106 and the server 102 may be through a network 108, such as the Internet.

Each of the devices 104 may be configured to communicate wirelessly with one of the network routers 106 using a wireless connection 110. The wireless connection 110 between the devices 104 and the network routers 106 may be through an appropriate wireless communications protocol, such as Wi-Fi, Bluetooth, or the like. In this manner, the devices 104 are able to communicate with the server 102 (through the network routers 106).

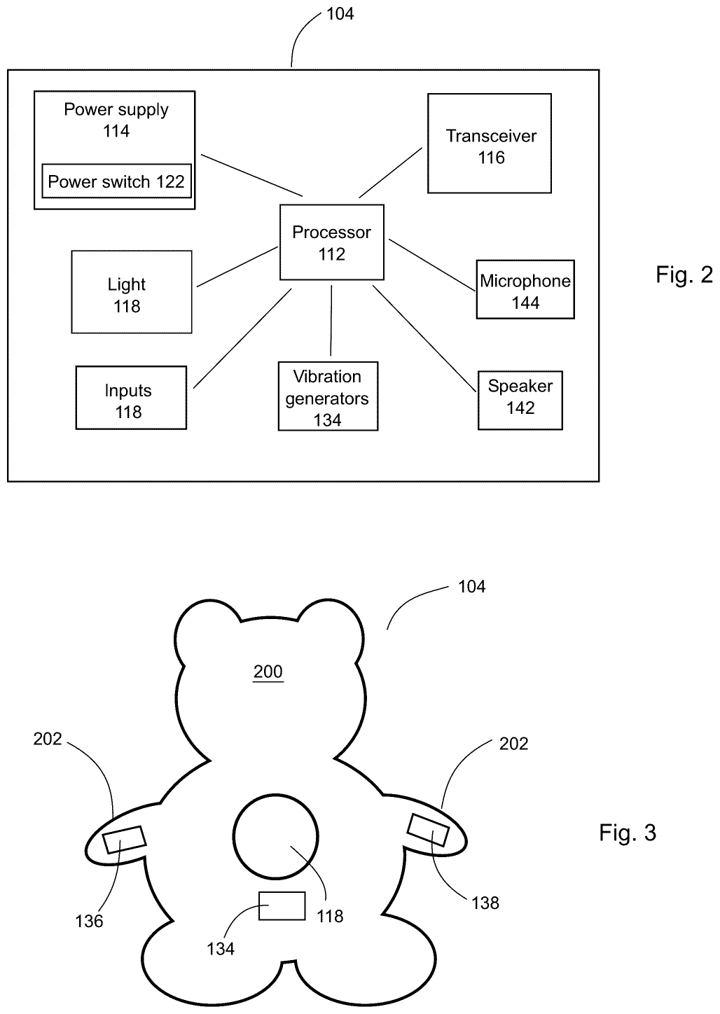

Referring to FIG. 2, each of the devices 104 may comprise a processor 112, a power supply 114, a transceiver 116 (for wirelessly communicating with the network routers 106), a light 118, and one or more inputs 120. The processor 112 may be configured to control and/or receive input from the other components of the device 104. In some embodiments, the devices 104 may take the form of a plush toy. For example, FIG. 3 depicts the device 104 in the form of a teddy bear 200. However, it is understood that the device 104 may take other forms, including the forms of other animals as well. In such embodiments, the inputs 120 may be located proximate to appendages 202 of the plush toy (e.g. the arms or legs of the teddy bear 200). The inputs 120 may be switches that activate when pressed (e.g. a biased switch or some other switch that activates when pressure is applied thereto). In some embodiments, the devices 104 may comprise at least two of the inputs 120 (such as, for example, having one of the inputs 120 located proximate to the ends of each of the two arms). However, it is understood that a greater number of the inputs 120 may be present and their locations on the devices 104 may vary.

The light 118 is configured to emit light and may comprise one or more light-emitting diodes (LEDs) or other suitable types of lighting (e.g. incandescent bulbs, fluorescent bulbs, etc.). In some embodiments, the light 118 is configured to emit light of different colors. For example, the light 118 may include components such as, for example, the 5050 PLCC6 RGB LED Red, Green, Blue.

The power supply 114 is configured to provide power to the components of the device 104. The power supply 114 may comprise a battery, such as, for example, a 4.2V 2000 mAh Li-Ion battery. The battery may be a rechargeable battery, in which case the power supply 114 may comprise a connector for connection to a charging source. In some embodiments, the device 104 may further comprise a power switch 122 for turning on and off the device 104. When the power supply 114 comprises a battery, the device 104 may be used (for at least a period of time) in locations without ready access to mains electricity. For example, the device 104 may be portable.

In some embodiments, the functionality of the processor 112 and the transceiver 116 may be combined in a single component, such as, for example, in the ESP32 MCU manufactured by Espressif Systems.

The system 100 may further comprise one or more computing devices 124 that may be used for registration and configuration purposes by users 10. The computing devices 124 may include smartphones, tablets, laptop computers, personal computers or the like. The computing devices 124 may be configured to download, install, and/or execute an application 126. The application 126 allows the computing devices 124 to communicate with the devices 104 and/or the server 102. In some embodiments, the computing devices 124 may be able to communicate with the server 102 through communications with the network routers 106.

The operation of the system 100 will now be described.

Each of the users 10 is able to use the application 126 on the computing device 124 to create an account that will be associated with the user 10. The information regarding the user 10 and the associated account (including, for example, the username of the user 10 and applicable password) may be communicated to the server 102 and stored in a database 128 maintained by the server 102. In some embodiments, the database 128 may be part of the server 102. In some embodiments, the computing device 124 is able to communicate with the server 102 through one of the network routers 106.

Once the user 10 has created an account, the user 10 is able to associate one or more of the devices 104 to the account for the user 10. Before one of the devices 104 may be used for communication purposes, it must be first associated with the account of one of the users 10. In order to do so, the user 10 may be prompted by the application 126 to place the device 104 with which the user 10 wishes to associate in proximity to the computing device 124 on which the application 126 is running. The application 126 may be configured to cause the computing device 124 to establish a configuration connection 130 with the device 104. This configuration connection 130 may be a wireless connection, such as through Bluetooth or the like. Once the configuration connection 130 between the computing device 124 and the device 104 has been established, the computing device 124 may configured by the application 126 to transmit to the device 104, using the configuration connection 130, information regarding the network router 106 (e.g. network identifier and network password) to allow the device 104 to communicate with the network router 106 using the wireless connection 110. Furthermore, the application 126 may prompt the user 10 to associate the device 104 to the account for the user 10. If the user 10 chooses to associate the device 104 to the account of the user 10, the application 126 may prompt the user 10 to provide a nickname for the device 104.

Each of the devices 104 may have a unique identifier. One way of generating the unique identifier is to use the unique identifier included in a wireless communications module used to enable a Wi-Fi or another type of wireless communication. The unique identifier may be transmitted by the device 104 to the computing device 124, which in turn may be transmitted to the server 102. The server 102 is configured to associate the device 104 with the account of the user 10 and store the information in the database 128. The user 10 may be able to associate additional ones of the devices 104 to the account of the user 10 in a similar manner. In some embodiments, each of the devices 104 may only be associated with the account of one of the users 10. In other words, once the device 104 has been associated to the account of one of the users 10, the device 104 can no longer be associated with the account of another one of the users 10.

The application 126 is also configured to allow the user 10 to delete an association between the account of the user 10 and one of the devices 104 already associated to the account. When the association is deleted, the device 104 may now be available to be associated with the account of another one of the users 10.

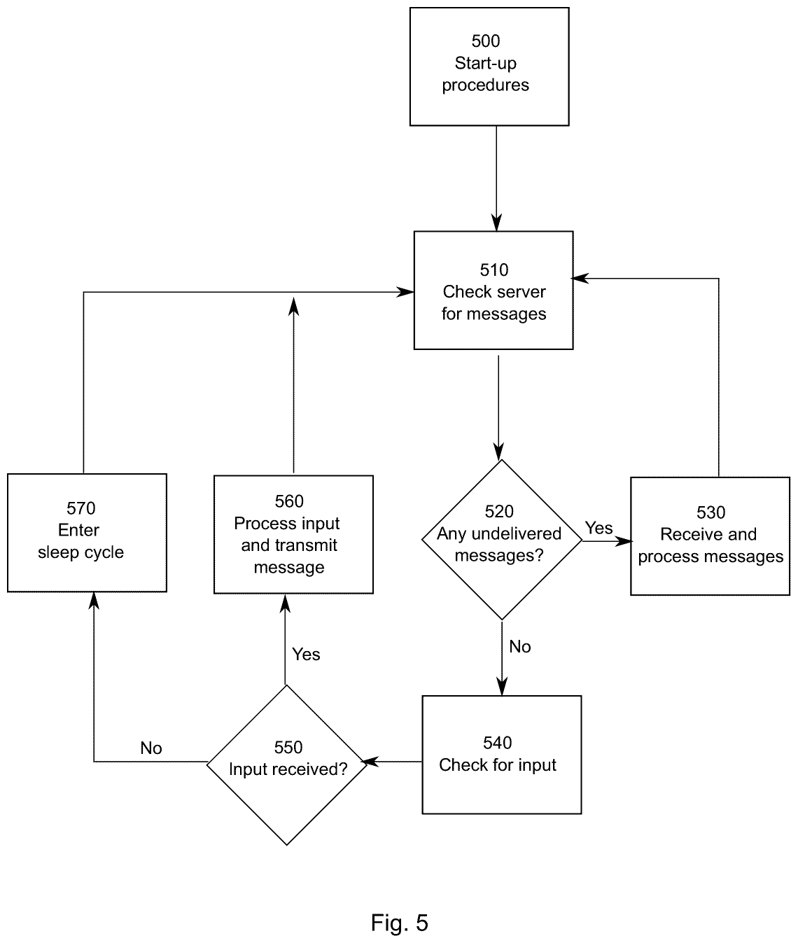

Referring to FIG. 5, the device 104a is associated to the account of the user 10a, while the device 104b is associated to the account of the user 10b. The user 10a is able to communicate (using the device 104a) with the user 10b (through the device 104b) in the following manner.

The device 104a will need to first establish a link with the device 104b before the devices 104a, 104b are able to communicate with each other. In order to do so, the user 10a can send an invitation to the user 10b to establish the link. The user 10a is able to send the invitation using the application 126 on the computing device 124a (used by the user 10a). In some embodiments, in order for the application 126 to know the destination of the invitation, the user 10a may provide to the application 126 some form of identification of the device 104b (e.g. the unique identifier for the device 104b or some other identifying feature). The application 126 may then be configured to query the server 102 as to the identity of the account for the user 10 to which the device 104b is associated (i.e. the user 10b). The server 102 may be configured to supply to the application 126 the identity of the account of the user 10 to which the device 104b is associated. The application 126 may then transmit the invitation to the appropriate one of the users 10.

The user 10b may receive the invitation through the application 126 on the computing device 104b (used by the user 10b). If the user 10b responds to the invitation by accepting the invitation, the response is transmitted to the server 102 by the computing device 104b. The server 102 is configured to update the database 128 to reflect creation of the link between the device 104a and the device 104b. The server 102 is further configured to transmit a notification to the computing device 104a to notify the user 10a that the user 10b has accepted the invitation. The user 10a may be prompted by the application 126 to provide a name or reference for the device 104b. The user 10a may also be prompted by the application 126 to select a color to be associated with the device 104b. Similarly, the user 10b may be prompted to provide a name or reference for the device 104a and to select a color to be associated with the device 104a. It is understood that the color that the user 10b has selected to be associated with the device 104a may be the same or different from the color selected by the user 10a to be associated with the device 104b.

Each of the devices 104 may have multiple links. In other words, each of the devices 104 may be linked to, and may communicate with, multiple other ones of the devices 104. In some embodiments, each of the multiple other ones of the devices 104 may be associated with a unique color, in order to assist in identifying which of the multiple other ones of the devices 104 communications are being exchanged.

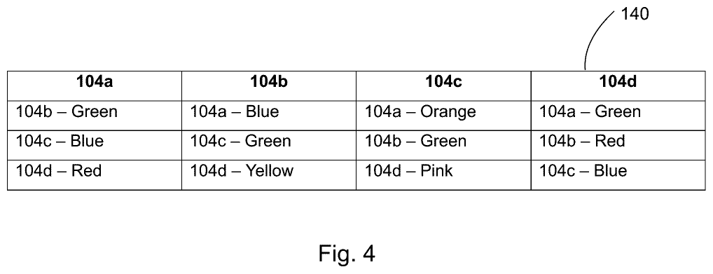

In some embodiments, information regarding the colors selected by the users 10 for associating with other ones of the devices 104 that are linked may also be stored in the database 128 in a color table 140, an example of which is shown in FIG. 4. Each of the columns in the color table 140 may depict the devices 104 linked to a particular one of the devices 104 and the colors selected by the user 10 of the particular one of the devices 104 to be associated with each of the devices 104 linked. For example, in the color table 140 depicted in FIG. 5, there are four of the devices 104 present (104a, 104b, 104c, 104d). For example, the device 104a is linked to the devices 104b, 104c, 104d, with the device 104b being associated with the color green, the device 104c being associated with the color blue, and the device 104d being associated with the color red. In this embodiment, each of the devices 104b, 104c, 104d linked with the device 104a have been associated to a different, unique color from each other.

Similarly, the device 104b is linked to the devices 104a, 104c, 104d, with the device 104a being associated with the color blue, the device 104c being associated with the color green, and the device 104d being associated with the color yellow. It is understood that the color associations used by the device 104a for the devices 104 to which it is linked may be different from the color associations used by the device 104b for the devices 104 to which it is linked, even if some of the devices 104 are in common with each other.

Links between the devices 104 may be deleted. For example, the link between the devices 104a, 104b may be deleted. Either of the users 10a, 10b may, using the application 126, delete the link between the devices 104a, 104b. When a link is deleted, the application 126 transmits the deletion to the server 102, which is configured to update the database 128 to reflect the deletion of the link. The color table 140 in the database 128 may also be updated to reflect the deletion of the link. It will no longer be possible to communicate between the devices 104a, 104b unless and until the link is re-established (e.g. by transmitting another invitation, as described above).

The user 10a may also, using the application 126, modify the name or reference of the devices 104 that are linked to the device 104a and/or modify the color associated with the devices 104 that are linked to the device 104a. Similarly, the user 10b may, using the application 126, modify the name or reference of the devices 104 that are linked to the device 104b and/or modify the color associated with the devices 104 that are linked to the device 104b.

Once the link has been established between the devices 104a, 104b, the user 10a may be able to use the device 104a to communicate with the device 104b for the user 10b (and vice versa). In some embodiments, the communications may take the form of activation of the light 118. This activation of the light 118 may further include modifying or varying the intensity or color of the light generated by the light 118 or altering the pattern of illumination of the light 118 (e.g. by flashing, etc.). In other embodiments, the devices 104 may further comprise vibration generators 134 that are configured to cause at least a portion of the devices 104 to vibrate when activated. For example, the vibration generators 134 may be located proximate to a central portion of the device 104. In such embodiments, the communications may take the form of activation of the lights 118 and/or activation of the vibration generators 134.

FIG. 5 depicts a flowchart showing operation of one of the devices 104. At step 500, the device 104 is powered on. The device 104 may attempt to establish the wireless connection 110 to the network router 106 using information already stored in the device 104. For example, the device 104 may attempt to establish the wireless connection 110 using the information about the network router 106 transmitted to the device 104 from the computing device 124 during initial configuration (e.g. the network name and the network password). The device 104 may be configured to use the light 118 as a mechanism for displaying a status of the device 104. For example, the light 118 may be configured to pulse a white color when the device 104 is attempting to establish the wireless connection 110 to the network router 106. The light 118 may be configured to display a different color when the wireless connection 110 has been established with the network router 106.

If the device 104 is unable to establish the wireless connection 110 with the network router 106 (such as because of a change in the network identifier and/or the network password), the user 10 may use the application 126 on the computing device 124 to establish the configuration connection 130 with the device 104 in order to update the network information on the device 104.

When the device 104 has successfully established the wireless connection 110 with the network router 106, the device 104 is configured to connect with the server 102. The server 102 is configured to retrieve from the database 128 at least a portion of the color table 140 that relates to the device 104 and to transmit that portion of the color table 140 to the device 104. For example, the portion of the color table 140 transmitted to the device 104 may include information on the other ones of the devices 104 that are linked to the device 104. It may also include information on the colors that the user 10 has selected to be associated with the other ones of the devices 104, and it may also include information on the colors that other ones of the users 10 have selected to be associated with the device 104. The portion of the color table 140 transmitted to the device 104 may be stored on the device 104.

At step 510, the device 104 is configured to check with the server 102 to see if there are any messages intended for the device 104 that have not yet been delivered to the device 104 (step 520). For example, such messages may have been sent when the device 104 was powered off or in sleep mode. If the server 102 indicates that one or more messages intended for the device 104 have not yet been delivered, the one or more messages are transmitted by the server 102 to the device 104 and processed (as described later) in step 530.

If there are no messages to be delivered by the server 102 (or if all messages have been delivered by the server 102), the device 104 may check for input by the user 10 on the inputs 120 at step 540. The device may be configured, at step 550 to determine whether the user 10 has pressed or otherwise activated the inputs 120 (such as to initiate sending a message). The user 10 may use the inputs 120 to send a message to another one of the devices 104. If the user 10 uses the inputs 120 to send a message, the information from the inputs 120 is processed to transmit the message at step 560. The device 104 then returns to step 510 to check with the server 102 to see if there are any messages intended for the device 104.

If the user 10 does not use the inputs 120 (e.g. no messages are sent), then after a predetermined amount of the time, the device 104 may enter a sleep cycle in order to conserve power in step 570. During the sleep cycle, certain components in the device 104 may be turned off for a period of time. After the period of time has expired, the device 104 may awaken from sleep and return to step 510 to check with the server 102 to see if there are any messages intended for the device 104.

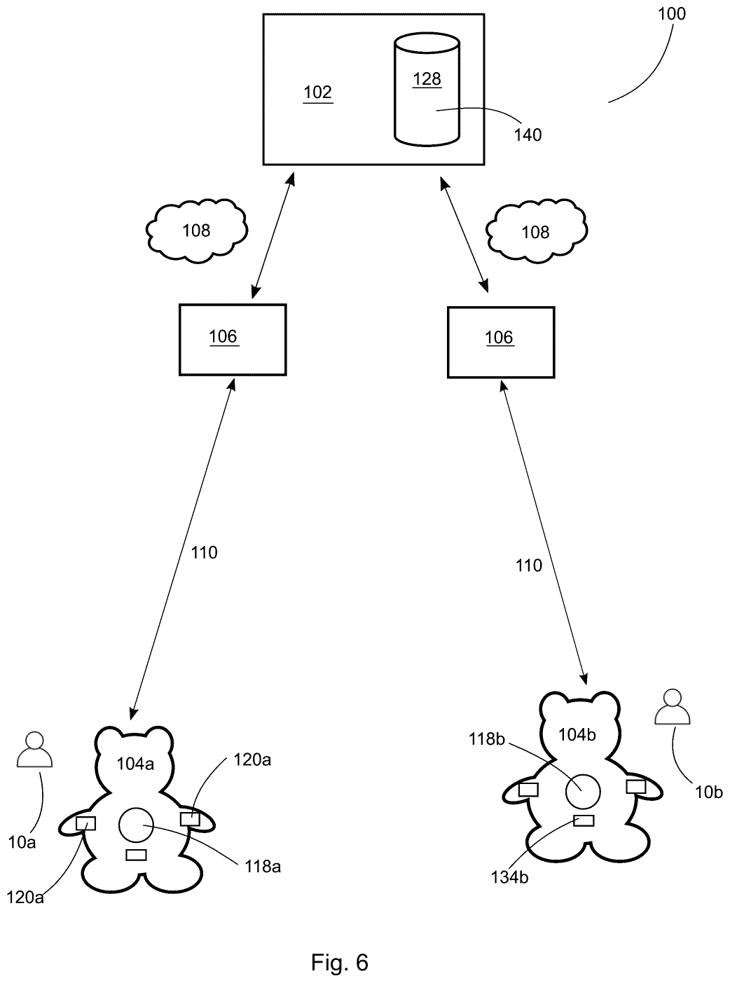

Referring to FIG. 6, the transmission of messages will now be described. If, for example, the user 10a wishes to communicate with the user 10b, the user 10a may use the inputs 120a on the device 104a to first select the device 104 to which the communication is to be sent (if the device 104a is linked to more than one other one of the devices 104). For example, in some embodiments, the user 10a may use the inputs 120a to first cycle through the devices 104 to which the device 104a is linked. This cycling may be carried out by successively pressing on one of the inputs 120a, with each of the successive presses causing a different color (associated with the different ones of the devices 104 linked to the device 104a) to be displayed by the light 118a. When the color of the desired one of the devices 104 is displayed (e.g. the color associated with the device 104b), the user 10a may use the inputs 120a to initiate the sending of the communication. For example, the inputs 120 may comprise first and second inputs 136, 138, with the first input 136 used for selecting the desired one of the devices 104 to send the message and the second input 138 used for initiating the sending of the communication.

When the user 10a uses the second input 138 to initiate the sending of the communication, the device 104a is configured to transmit a message to the server 102 (e.g. through the network router 106). The message may comprise information regarding the identity of the source of the communication (e.g. the device 104a) and the destination of the communication (i.e. the device 104b). The device 104a may use information from the portion of the color table 140 retrieved from the database 128 to identify the destination of the communication (using the color selected by the user 10a with the inputs 120).

The server 102 is configured to receive the message and is further configured to mark the message as received from the device 104a and addressed to the device 104b. In some embodiments, the server 102 may be configured to store in the database 128 all messages received from the devices 104. In other embodiments, the server 102 may be configured to store in the database 128 only a subset of messages received. For example, the server 102 may be configured to store in the database 128 only messages received within a certain period of time (e.g. the last 24 hours).

When the device 104b connects to the server 102 to check if there are any messages that are intended to be delivered to the device 104b, the server 102 may be configured to retrieve, from the database 128, the message sent from the device 104a and to transmit the message to the device 104b. The server 102 may further be configured to mark in the database 128 that the message has been transmitted to the device 104b.

When the message is received by the device 104b, the device 104b is configured to determine, from information in the message, the identity of the source of the communication (e.g. the device 104a). The device 104b is further configured to use information from the portion of the color table 140 retrieved from the database 128 to determine the color selected by the user 10b to be associated with the device 104a. The message may be played by the device 104b by causing appropriate activation of the light 118b, including displaying the color selected by the user 10b to be associated with the device 104a. In addition, the device 104b may cause the vibration generators 134b to activate, effecting vibration of at least a portion of the device 104b.

The user 10b is able to communicate with the user 10a in a similar manner.

In some embodiments, the messages transmitted between the devices 104 may also include audio (in addition to or in substitution of light and/or vibration). In such embodiments, the devices 104 may further comprise a speaker 142 and a microphone 144. The user 10 is able to use the inputs 120 in order to choose to include a recording as part of the message to be transmitted to another one of the devices 104. For example, the user 10 may use the second input 138 to choose to include a recording as part of the message to be transmitted. The user 10 may use the first input 136 to cycle through the colors (associated with the other ones of the devices 104 linked to the device 104) until the desired color is selected. Instead of pressing on the second input 138 to send a message (as before), the user 10 may double-click on the second input 138 to initiate audio recording by the microphone 144. The user 10 may then speak and/or provide audio. After the user 10 has finished, the user 10 may stop the audio recording and transmit it to the server 102 by double-clicking the second input 138 again. The message is transmitted to the server 102 in a similar manner as described above; however, the message now includes a digital copy of the audio recording (as recorded by the microphone 144).

When a message containing a digital copy of an audio recording is received by the device 104, the device 104 processes the message in a similar manner as described above, including activating the light 118 to display the appropriate color and/or activating the vibration generators 134. However, the device 104 is also configured to play, using the speaker 142, the digital copy of the audio recording.

In some embodiments, the user 10 may be able to retrieve and replay messages from the server 102 that were sent during a pre-set period of time (e.g. from the last 24 hours). For example, the user 10 may be able to use the inputs 120 to instruct the device 104 to retrieve and replay messages from the server 102 during the pre-set period of time, even if those messages were already previously retrieved and replayed. The user 10 may initiate this procedure by using the inputs 120, such as by double-clicking the second input 138. This will cause the device 104 to connect to the server 102 and request the retrieval of those past messages. The server 102 may be configured to transmit to the device 104 those messages, at which time the device 104 will process and play the messages (including any audio recordings, if applicable).

In some embodiments, the user 10 may be able to use the application 126 on the computing device 124 to schedule or otherwise delay the time at which the messages sent by the device 104 are delivered. The user 10 may also be able to schedule or otherwise delay the time at which the messages sent to particular ones of the devices 104 are delivered.

In some embodiments, the user 10 may be able to use the application 126 on the computing device 124 to transmit and to receive messages. For example, the user 10 may be able to use the application 126 to send a message on behalf of one of devices 104 associated with the account of the user 10. In addition, the user 10 may be able to use the application 126 to receive a message on behalf of one of the devices 104 associated with the account of the user 10.

It will be appreciated by those skilled in the art that the preferred embodiment has been described in some detail but that certain modifications may be practiced without departing from the principles of the invention.

1. A communications system among users, the system comprising:
a server; and
a plurality of devices, each of the devices associated with one of the users and comprising:
a transceiver configured to communicate with the server;
a light; and
one or more inputs;
wherein one of the devices is configured to be linked with other ones of the devices, each of the other ones of the devices associated with a different unique color selected by the user associated with the one of the devices from a plurality of colors;
wherein the one of the devices is configured to transmit a message to a particular one of the other ones of the devices by (1) the user associated with the one of the devices selecting, using the one or more inputs and the light, the different unique color associated by the one of the devices with the particular one of the other ones of the devices, and (2) the one of the devices transmitting the message to the server;
wherein the server, upon receipt of the message, is configured to determine which of the other ones of the devices is the particular one of the other ones of the devices to which the message is intended; and
wherein each of the other ones of the devices is configured to connect with the server, and upon the particular one of the other ones of the devices connecting with the server, the server is configured to transmit the message to the particular one of the other ones of the devices.

2. The communications system of claim 1 further comprising a database in communications with the server, wherein the database is configured to store information relating to the different unique colors associated by each of the devices with the other ones of the devices linked to each of the devices.

3. The communications system of claim 1, wherein upon receipt of the message by the particular one of the other ones of the devices, the light on the particular one of the other ones of the devices is configured to illuminate with the different unique color associated by the particular one of the other ones of the devices with the one of the devices.

4. The communications system of claim 1, wherein the selecting the different unique color associated by the one of the devices with the particular one of the other ones of the devices is by using the one or more inputs to sequentially display, using the light, the plurality of colors to select the different unique color.

5. The communications system of claim 1, wherein each of the devices further comprises a microphone, and wherein the message comprises an audio recording recorded by the microphone.

6. The communications system of claim 5, wherein each of the devices further comprises a speaker, and wherein upon receipt of the message by the particular one of the other ones of the devices, the particular one of the other ones of the devices is configured to play the audio recording using the speaker.

7. The communications system of claim 1, wherein the one or more inputs comprises two inputs.

8. The communications system of claim 1, wherein at least one of the devices is in a form of a plush toy.

9. The communications system of claim 8, wherein the plush toy comprises two or more appendages.

10. The communications system of claim 9, wherein at least one of the one or more inputs is located proximate to one of the appendages.
